(19) United States
(12) Patent Application Publication
(10) Pub. No.: US 2011/0066955 A1
(43) Pub. Date: Mar. 17, 2011

(54) System and Method for Managing a Written Transaction

(75) Inventors: Robert A. Olson, Los Altos, CA (US); Mark R. Goines, Los Altos, CA (US); Christian Wiedmann, San Mateo, CA (US); Kevin H.C. Monahan, Santa Cruz, CA (US); Sandhya K. Jaideep, San Jose, CA (US)

(73) Assignee: VeraCarta Corporation, Menlo Park, CA (US)

(21) Appl. No.: 12/325,896

(22) Filed: Dec. 1, 2008

(51) Int. Cl. G06F 3/01

(52) U.S. Cl. 715/752

(57) ABSTRACT

A system and method for managing transactions that include numerous documents and written electronic communications between a plurality of participants is disclosed. Communications and documents related to the transaction are obtained and analyzed to determine the relationships between them and the parties authorized to view each. The communications and documents are stored with the relationship data so that a participant may view authorized items in a manner that indicates the particular relationship in which the participant is interested.

### FIELD OF THE INVENTION

The present invention relates generally to online collaboration systems. More specifically, the present invention relates to managing transactions that include numerous documents and written electronic communications between a plurality of participants.

### BACKGROUND OF THE INVENTION

There are many situations in which a group of participants engages in a transaction that requires communication between them, as well as the drafting and negotiation of documents. There may be multiple parties involved, for example in a transaction in which a startup company secures a round of funding from a number of investors. Other such situations might include multiple parties negotiating a joint venture or a settlement of a lawsuit. Even in cases where there are only two parties, there may be multiple individuals at each party who need to review or contribute to the transaction.

Email has been used for collaboration and document development in such situations for a number of years. In general, email collaboration is accomplished by the exchange of email messages, with the documents under discussion generally sent as attachments to the emails.

The sender of an email message controls the list of recipients and the format and content of the message. However, standards of practice on a variety of issues vary widely between organizations, and often even between individuals within an organization. Some people will put their comments in the body of the email, while others will insert comments in the documents. Some will edit the documents themselves while others will only propose changes in the emails. When responding to an email from another, some people will use the “reply” or “reply all” function, while others may reference one or more prior emails, and still others will write a new email; in any of these cases, they may or may not use the same subject line as the email to which they are responding.

With respect to documents, different organizations and people may also have different ways of using, naming and organizing documents, and they may even use different programs to create or edit documents. When modifying a document, some may track the changes they make to the document, while others may not but simply save the revised document with no indication of what changes were made. Some people may retain the original name of a document when it is modified, possibly indicating that the document is a new version of the original document, while others may give the modified document a new name, again perhaps to be consistent with their or their organization's naming conventions.

A complicated transaction may involve tens or even hundreds or emails and different versions of the relevant documents. Further, any individual may be involved in any number of transactions, and thus have an email inbox of possibly hundreds or thousands of emails. The recipient of such emails typically attempts to organize the incoming messages in such a way that both the content and the context of the message can be recovered in a convenient manner, but as the emails and documents become more numerous the administrative overhead of managing the collaborations rapidly escalates.

The lack of consistency in naming and indexing may make it extremely difficult to find the emails and documents related to a specific transaction. This can result in lost or unread items, confusion and lost time and productivity due to miscommunication. Thus, a participant may be forced to spend significant time in administration in order to locate the materials needed to be able to do actual work on a project.

Despite these disadvantages, email remains the premier collaboration tool for these types of transactions, both within and between organizations. Email is available to anyone with a computer or electronic communication device, convenient and generally reliable, and the various available email platforms are generally interoperable. and perhaps most importantly, only an email address is required to participate in a collaboration in this way; this dramatically lowers overhead, training and the need for any prior arrangement between the parties.

Another advantage to using email collaboration in this way is that the specifying of recipients by the sender of a message also serves to explicitly grant access to the contents of the message, including any attachments. Particular in situations where the collaboration is between entities that lack a common parent, this specification often is the only direct expression of access permissions.

In addition to the use of email, the use of network based electronic document management (EDM), such as via online web sites, is also well known in the art. In fact, such hyperlinked sharing and versioning of scientific documents was one of the original motivations for the invention of the World Wide Web. In a typical document management product, documents and revisions are explicitly uploaded to the document management system. The systems generally allow for explicit selection of access controls to specify restrictions on who can access and manipulate each document. Examples of these systems include online deal rooms (hosted document repositories) such as IntraLinks, as well as enterprise solutions such as those provided by EMC/Documentum (eRooms) and Microsoft (SharePoint). The primary benefit of the typical electronic document management system is that a single central database of documents and versions is maintained. In theory all participants should be able to rely on this central database to synchronize their collaboration efforts.

In spite of this, EDM systems are poorly suited for multi-entity negotiations for several reasons. First, effective use of the systems generally requires forethought in the organization of the collaboration as well as cooperation by the participants in following that organization. This is generally an unreasonable expectation for most multi-entity negotiations, which may often include ad-hoc changes in both the participants and documents.

In addition, EDM systems typically are not convenient for multiple participants in a project collaboration, with the possible exception of active users within the organization hosting the EDM system. A common problem is that multiple steps are required to use the EDM system to its full capability. The typical usage in multi-party negotiations is to email the documents to the participants and then add the documents to the document repository. To do this, a user must log in to the system (using potentially different credentials for each negotiation), navigate to the relevant document(s), and then explicitly upload each new revision. The number of steps is a significant disincentive to use for casual participants in the collaboration, especially if they are involved in multiple concurrent negotiations.

Also, many users will add revisions to the repository only sporadically, often only when a version has been agreed to by several parties. Consequently, the “real” negotiation tends to happen outside the purview of the document management system, with only the results recorded.

Still further, documents stored in a typical EDM system are divorced from the context in which they were sent, such as email bodies, email threads and other documents circulated at the same time. The content of the email bodies and the threading of the messages can be very important, for example in establishing which version of a document is most relevant.

Finally, EDM document management systems are generally not interoperable, most having their own proprietary platforms, and they are not nearly as ubiquitous as email. These factors may make it difficult to reuse knowledge from one project in a subsequent project.

Projects that cross entity boundaries must thus rely heavily on voluntary collaboration between the parties involved. As each party will often have multiple conflicting priorities to manage, it is particularly important for participants to be able to rapidly identify their own pending tasks, as well as to be able to prompt others regarding tasks that may be not be receiving necessary attention. In most project management automation products, project managers are expected to manually manage task assignments and completions. But in practice, these manual techniques require too much interaction and are difficult to enforce in multi-entity projects, except for very large projects where it is possible to justify and provide the administration that is needed.

It would thus be desirable to provide a collaboration and project management system that preserves the convenience and ubiquity of email-based collaboration while also providing the benefits of a centralized document and communications management solution.

### SUMMARY OF THE INVENTION

The present invention advantageously combines the use of email with document management techniques to create an online system that is particularly well suited for collaboration between persons and entities that lack a common parent, such as business-to-business contract negotiations.

In a method of managing a written transaction between a plurality of participants according to the present invention, a computer system obtains a plurality of communications and documents that are related to the transaction. The system determines which participants are parties to each of the plurality of communications, whether any of the documents are related to any of the communications, any relationships between the communications, and any relationships between the documents. The communications and documents and all of the determined relationships between them are stored, and are then displayed in a variety of desired ways on an electronic display in the computing system.

The system examines the emails to determine certain characteristics of each, which in various embodiments may include the date, sender, recipient, subject line, attachment, key words or content. The emails may be displayed to a participant who is authorized to view them in groups according to any of these factors so that the participant is able to see the relationships between them.

The system also examines the documents or other attachments (collectively called “documents” herein) to each email and similarly determines various characteristics of the documents. In some embodiments, this may include the title, author, date and whether the document is a version of another document in the system, i.e. whether the two documents are near duplicates of one another. Again a participant may view documents which he or she is authorized to view in groups according to any of the factors so that the relationships between the documents may be seen.

By the use the present invention, participants obtain both the convenience of email and the benefits of centralized document management, with automation that reduces cost and effort and increases consistency and completeness.

### BRIEF DESCRIPTION OF THE DRAWINGS

FIG. 1 is an illustration of a network environment in which the present invention may be used.

FIG. 2 is a flowchart of a method according to one embodiment of the present invention.

FIGS. 3 through 12B are portions of displays that may be shown to participants of a project in various embodiments of the present invention.

### DETAILED DESCRIPTION OF THE INVENTION

The present invention allows participants in a plurality of written transactions that each may include a number of other participants at other entities, as well as large numbers of emails, documents, and other electronic communications, to efficiently organize their view of, and thus their ability to work on, the transactions in which they are involved.

For the reasons set forth above, the communications between participants are believed to be most likely to be emails, and thus emails are discussed most prominently herein. However, other written electronic communications between parties such as text messages may also be captured and processed in the present invention, and the discussion of emails is not intended to limit the invention, which is defined by the claims herein.

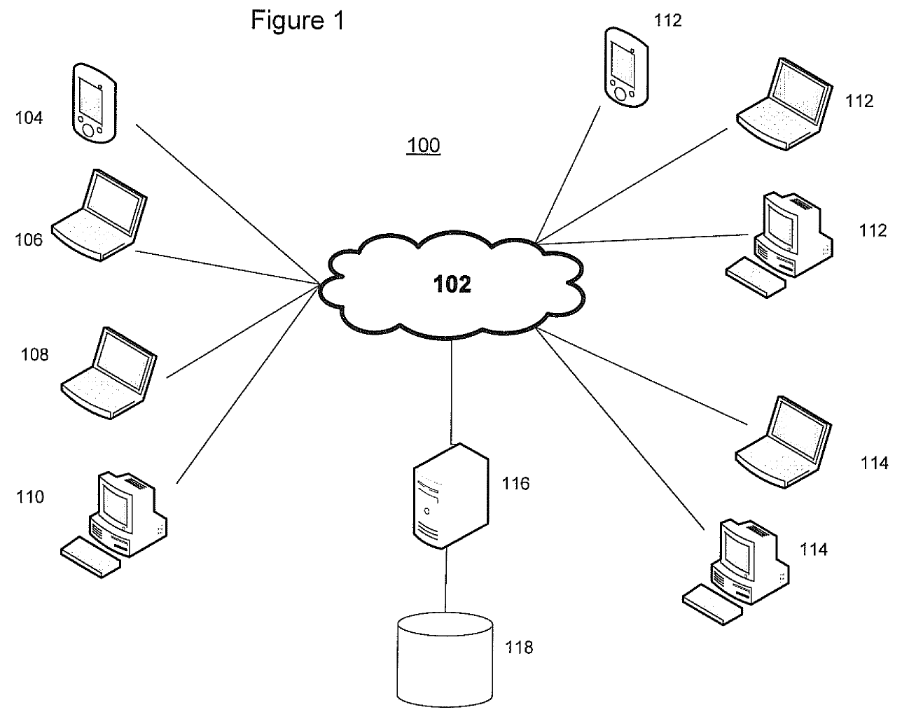

FIG. 1 shows a communication network environment 100 in which the present invention may be used. Participants at a first entity or organization may send and receive email and access the Internet 102 through a variety of electronic communication devices, such as a “smart” cellular telephone 104, laptop computers 106 or 108, or a desktop computer 110. Any other user device capable of sending and receiving email and accessing the Internet may be used as well. Participants 112 and 114 at other entities or organizations may also access the Internet through similar devices.

One or more servers 116 are similarly connected to the Internet 102, and contain or have access to one or more data storage devices 118. Server 116 receives and stores the emails and documents that are sent between the participants 104-114, and analyzes, sorts, stores and displays them as discussed herein.

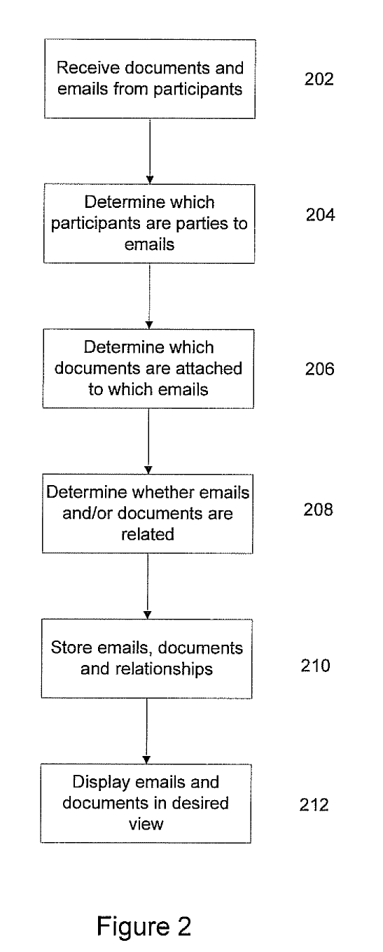

FIG. 2 is a flowchart of a method of managing a written transaction between a plurality of participants in a computing system according to one embodiment of the present invention. Such a method may, for example be performed by server 116 in FIG. 1. It will be clear to one of skill in the art that the order of some steps may be varied.

At step 202, the documents and emails between the participants that relate to the transaction of interest are received by the system. The emails are examined to determine which participants are parties to, i.e., senders or recipients of, which emails at step 204. The emails are also examined to determine which documents are attached to which emails, at step 206.

At step 208, the emails and documents are analyzed to determine whether they are related, and, if so, what those relationships are. The emails and documents, and the determined relationships between them, are then stored at step 210, for example in a database in data storage device 118 in FIG. 1. (Note that the emails and documents may alternatively be stored when received at step 202.) At step 212, the emails and documents are displayed in a desired fashion. These steps will now be described in more detail.

Analysis of the email traffic between participants on a project obviously first requires that the system be given access to the emails. There are various ways in which this may be done. In some embodiments, the simplest solution is to directly import the emails and documents into the system by copying them to a database, for example in data storage device 118. The emails and documents need not be copied individually; for example, in some embodiments a number of emails and documents may be attached to a single email which is sent to an email address established specifically for the receipt of imported items.

In other embodiments, emails and documents may be imported via the use of a project-specific email address. In such an embodiment, each project may be given a unique domain name, using the familiar Internet Domain Name System (DNS) (RFC 1034), which may be used to create project-specific email addresses. Each authorized participant in a project is given a project-specific email address for use in project communications. Use of a project-specific email address ensures that a copy of any email using those addresses will be routed to the system's server for processing as part of that project.

One version of such an email address might be:
participantname@projectname.participantsentity.servername.com
   Thus, just as an email address might uniquely identify an individual at an email hosting service such as Yahoo Mail or Gmail, or at a company, this type of email identifies a participant in the project “projectname,” and indicates that the participant is affiliated with entity “participantsentity.” The use of the domain “servername.com” ensures that the email is routed to the server, which is able to include the email in the appropriate project and identify the sender and recipients from these addresses.

Additional reserved project-specific email addresses may be used to direct email to the application itself rather than to a project participant. An example of a reserved project-specific email address might one beginning with “cc@” that results in a “carbon copy” of the message being directed to the server. There could also be sub-projects or sub-accounts represented by alternative domain name formulations.

The direct import method is useful for situations where the participants do not wish to have to use and keep track of project-specific email addresses. Direct import may also be used for capturing email that was exchanged prior to the creation of the project as well as email that does not originally include a project-specific email address.

In many embodiments, the emails are processed by standard procedures, but in some embodiments may be processed by applying project-specific rules. In some embodiments of the invention, once the relevant project is identified, an email is delivered to the mail server 116, which breaks the email into its constituent parts according to the Multipurpose Internet Mail Extensions (MIME) protocol, RFC 822 and successors. In particular this includes sender and recipient email addresses, subject, time stamp and attachments.

As illustrated in FIG. 2, an email is first examined to determine which participants are parties to the email, i.e., the sender and recipients. Next, an email is examined to determine whether it has any documents attached thereto, and if so what the documents are. In this context, “documents” includes any form of attachment that may be of interest in a collaborative project. While many documents will be those that involve word processing, they may also include spreadsheets, databases, pictures, audio or video files, PDF files, or any other format.

Next, it is determined whether any of the emails or documents are related to each other in any way other than documents being attached to the emails as above. This may be done in a variety of ways, some of which are well known in the art. For example, it is well known to group emails by the date sent or received, or to group them by a common sender or first addressee. It is also known to group a “thread” of emails together, i.e., where each email other than the first is a response to a preceding email, or to group together emails having a common subject line.

In one embodiment, the present invention allows for grouping together emails that have common attachments, i.e., in a group each email has attached to it the same document. Further, as below, emails may be grouped such that each email in the group has attached a slightly different version of that same document.

It is next determined whether the documents are related to each other, and in particular whether there are multiple versions of the same document. In some embodiments this is done by “near duplicate detection,” a technique known in the art for determining whether any two documents are nearly identical.

One such document classification algorithm uses Dirichlet-smoothed Kullback-Leibler (KL) divergence as a baseline distance metric, as described in Yang and Callan, “Near-Duplicate Detection by Instance-level Constrained Clustering,” Proceedings of the 29th Annual International ACM SIGIR Conference on Research and Development in Information Retrieval, Aug. 6-11, 2006, Seattle, Wash.

In the present application, some of the simple constraints described in Yang and Callan cannot be used since the anticipated body of documents is more diverse than those contemplated therein. Accordingly, the algorithm used in the present invention does not exactly follow the approach of using instance-level constraints but rather uses the baseline distance to drive clustering. In addition, it has been empirically determined that better results are obtained in the present application if the algorithm uses the average of the two non-symmetric distance measures between two documents rather than the minimum distance.

One of skill in the art will recognize that there are many alternative algorithms which may be applied to do near duplicate detection. In addition to the technique described above, it is believed that at least one such solution is patented by Google, and at least one solution may be licensed commercially, from Vivisimo, that uses a set of proprietary algorithms which purports to achieve a result superior to that described herein.

How close the documents need to be to each other to be considered nearly identical may vary by application; for example, in certain situations a form document that is identical other than the name of the signor might be considered a single document, while in other situations it may be appropriate to consider each a separate document. Documents need not have the same titles, or even be in the same format; for example, PDF documents may be compared to documents prepared in a word processing application by comparing the text recovered from each.

It is also possible to exercise control over the extent to which documents may be presumed to be nearly identical to each other. For example, in some situations it may be reasonable to assume that if document A is nearly identical to document B, and document C is nearly identical to document B, then document A is also nearly identical to document C. In other situations, it may be desirable to compare document A directly to document C before making this determination.

Note that in the situation described above in which it is desirable to group emails by the attachment of versions of the same document, the analysis of documents may either be performed before other relationships of the emails are determined, or other comparisons of the emails may be made and the additional relationship of the common attachment may be added later.

Once the relationships between the emails and documents are determined, the relationships are stored in the database. If the emails and documents have not been previously stored, they are stored as well. The emails and documents, and the determined relationships between them, may now be displayed in any desired way. In some embodiments, this is done by the participant logging into a website hosted by the server 116 and utilizing a graphical user interface (GUI) on the participant's computer, smartphone, or other web-capable device to specify how the participant wishes to view the emails, documents and relationship data.

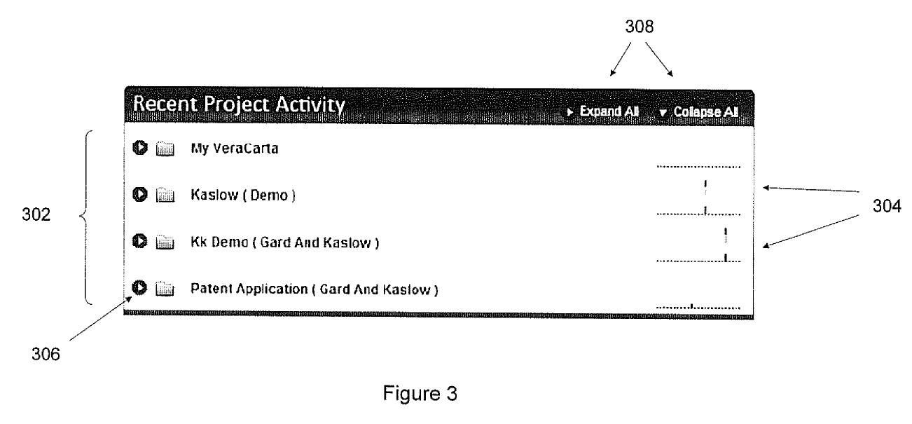

Examples of possible embodiments of such a display will now be illustrated. FIG. 3 is an illustration of a portion of a screen such as might be displayed when the participant logs into a website hosted by a server performing the functions described herein. The participant is presented with a menu 302 of available projects in which he or she is involved. While the menu is here labeled as “Recent Project Activity,” any title may be used, and the menu may consist of all projects in which the participant has ever been involved, all projects not indicated as complete, only projects with activity within some period of time, or any other desired list of the participant's projects. If desired, a title, such as “My VeraCarta,” may be presented for this “participant homepage.”

Various other information may be displayed if desired. For example, as shown in FIG. 3, an “activity bar” 304 may indicate how much activity there has been over some increment of time, such as the last month, last 3 months, or any other desired time period, with the time being presented as the horizontal axis and the most recent activity on the right and earlier activity to the left, and the height of each vertical bar indicating the amount of activity at a particular time.

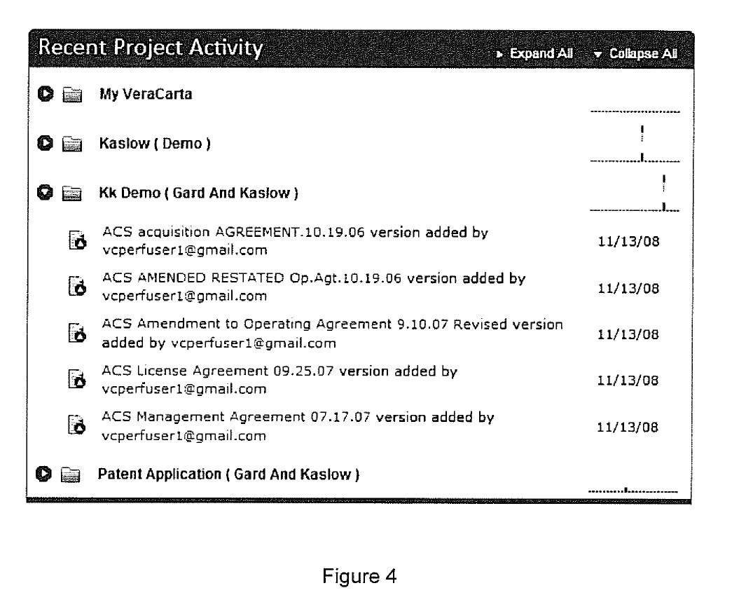

If desired, buttons 306 may be used to expand and collapse the view of each project from the homepage of FIG. 3. FIG. 4 shows the result of clicking on the button next to “Kk Demo.” A list of the documents related to the project entitled “Kk Demo” is now shown, and the arrow on the button points down, indicating that the project view has been expanded. Clicking on the button again returns the view to that shown in FIG. 3. If further desired, buttons 308 which will expand or collapse the views of all of the shown projects may be added. Alternatively, rather than displaying the documents associated with each project, expanding a project might result in a list of the emails associated with the project.

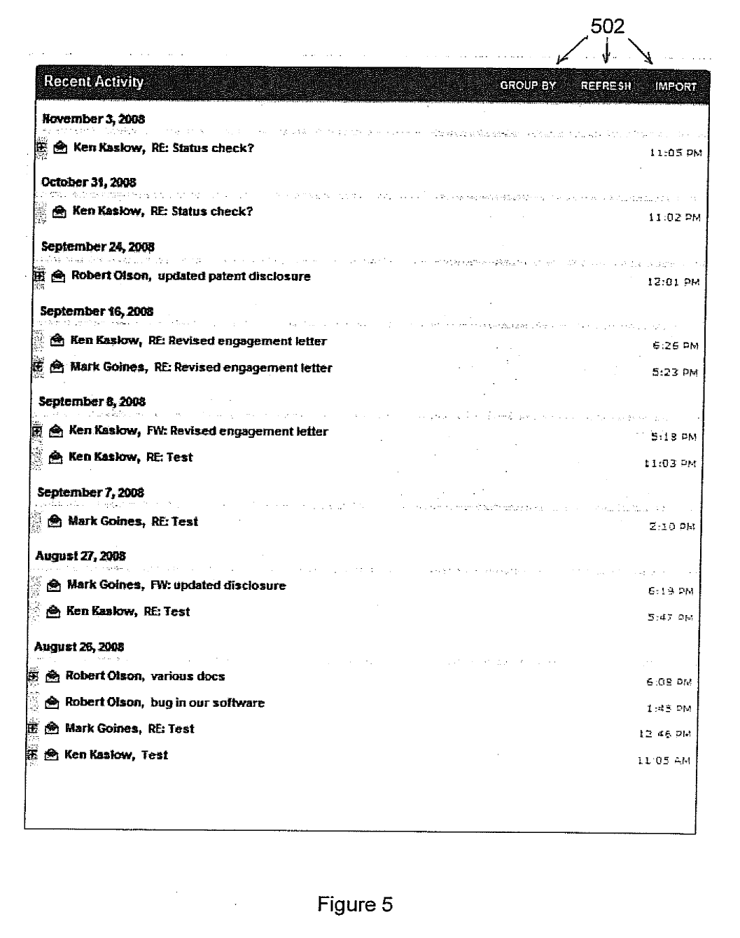

Selecting a project may take the participant to another page on which further information about the project is displayed. FIG. 5 is an illustration of a portion of a page such as might be displayed when the participant selects a project by, for example, clicking on its name. In FIG. 5, the emails associated with the project are displayed in a preselected default order by date, with the various dates as group headings. In the illustrated view, within date the emails are displayed by time, but any other order may be chosen if the system is programmed to allow it. Any default view, including but not limited to those described below, may be chosen in advance, either for the entire system or for specific projects.

Any other desired functions may be included. As illustrated in FIG. 5, there are several action buttons 502 in the shown portion of the screen. One is labeled “import” and allows the participant to import additional emails or documents as described above; clicking on this box may result, for example, in a dialog box with instructions to the participant to drag any emails desired to be imported into the box and to click a “finish” button or hit the return key when done. A button 502 labeled “refresh” allows the participant to update the screen to include any new information that has been entered into the system since the participant arrived at the screen of FIG. 5.

The action button 502 labeled “group by” allows the participant to view the emails shown in different relationships as desired. For example, clicking on the “group by” button 502 may result in a pull down menu (not shown) that allows the user to view the emails grouped by date, by sender, by subject line, or by document attached.

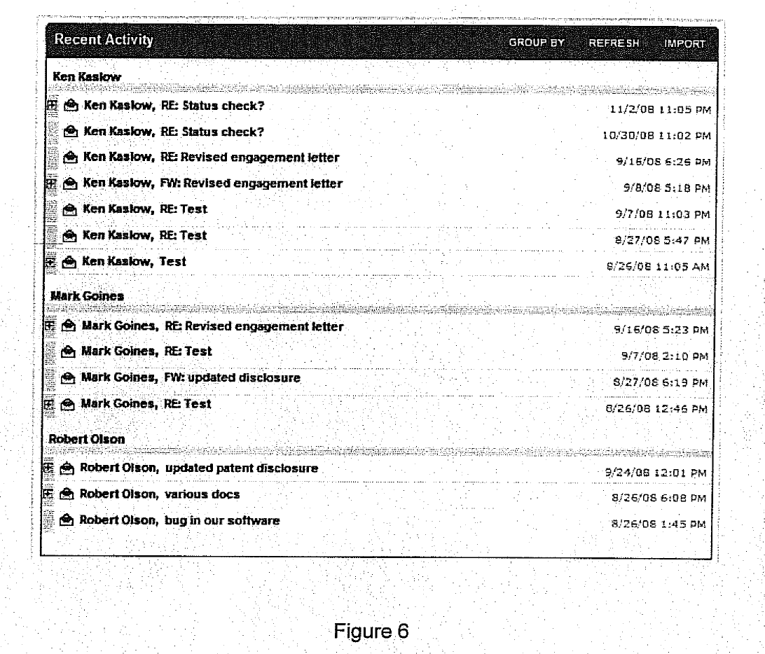

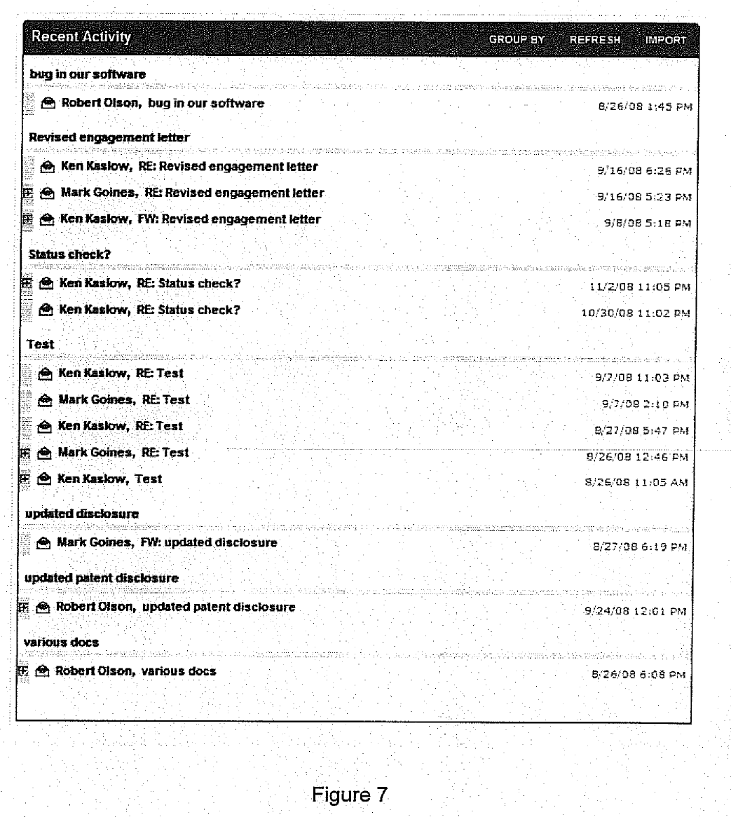

Thus, selecting the “group by” button 502 and then choosing to group by date will not change the display since by date is the default view. However, this function may be useful if the participant has changed the view and wishes to return to the grouping by date. Choosing to group the emails by sender will result in the view shown in FIG. 6, in which the names of the senders are now the group headings. Choosing to group by subject line will result in the view of FIG. 7, with the subject lines of the emails shown as the group headings. (Note that “RE” and “FW,” which are typically added by email systems when a participant replies to or forwards an email, are ignored for this purpose.) Within each group, the emails are listed by date and time, but other orders may be chosen if programmed in the system.

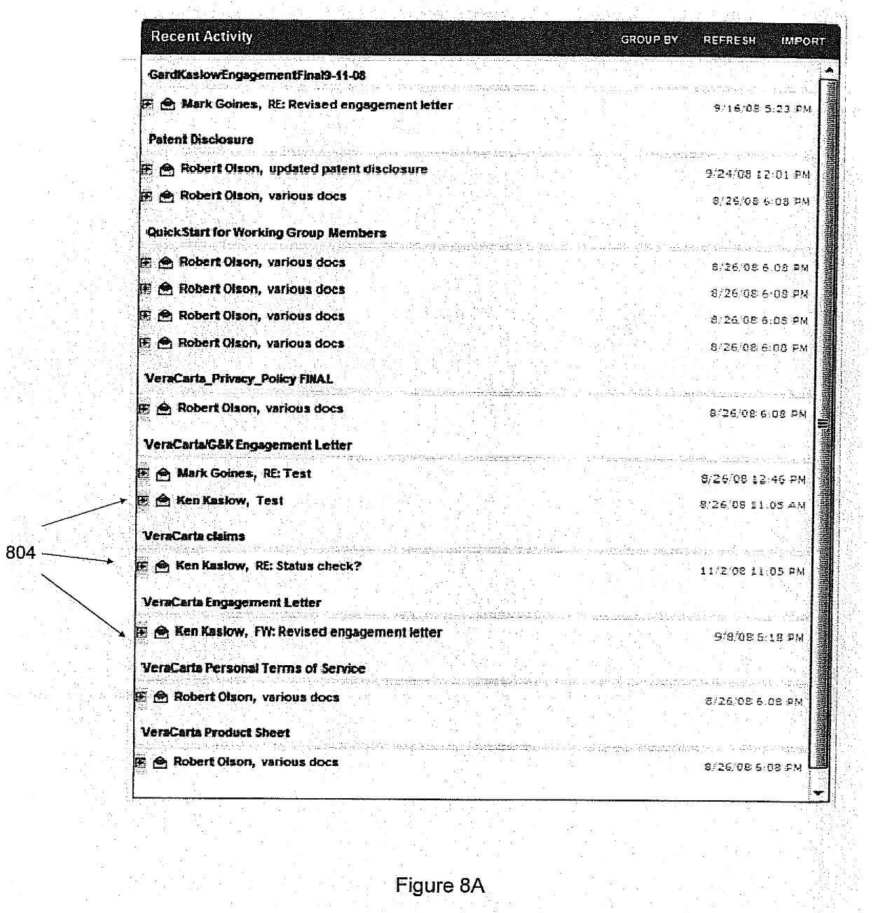

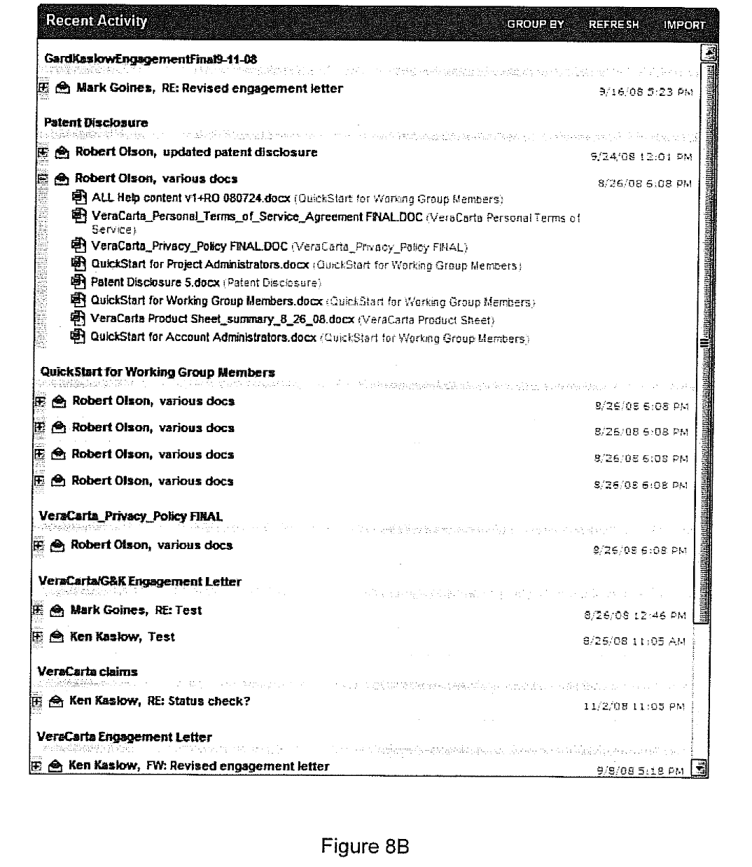

Selecting “document” from the pull down menu of the “group by” button 502 will result in the screen portion of FIG. 8A, with the emails now grouped by what document is attached to each email, with the document titles as the group headings. Note that a single email may appear multiple times on this view; for example, an email shown from Robert Olson on Aug. 26, 2008, is listed as having had attached to it documents entitled Patent Disclosure, Quick Start for Working Group Members, VeraCarta_Privacy_Policy FINAL, VeraCarta Personal Terms of Service, and VeraCarta Product Sheet.

In any display of the emails, such as those in FIGS. 5 to 8A, a sign, such as the “+” symbols 804, may indicate that there are one or more documents attached to an email. Clicking on the “+” symbol 804 for the email entitled “various docs” in the group titled “Patent Disclosure,” for example, may result in the display of FIG. 8B, in which that email has been expanded to show that there are a number of documents that were attached to the email. In a typical technique of the art, the “+” symbol has now become a “−” symbol, and clicking on it returns the display to the form of FIG. 8A.

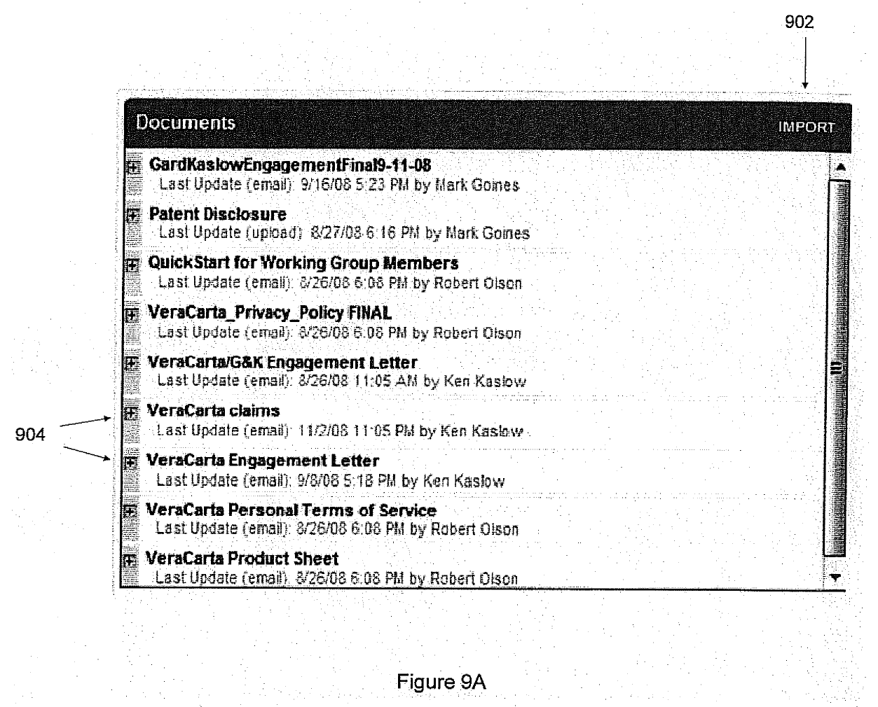

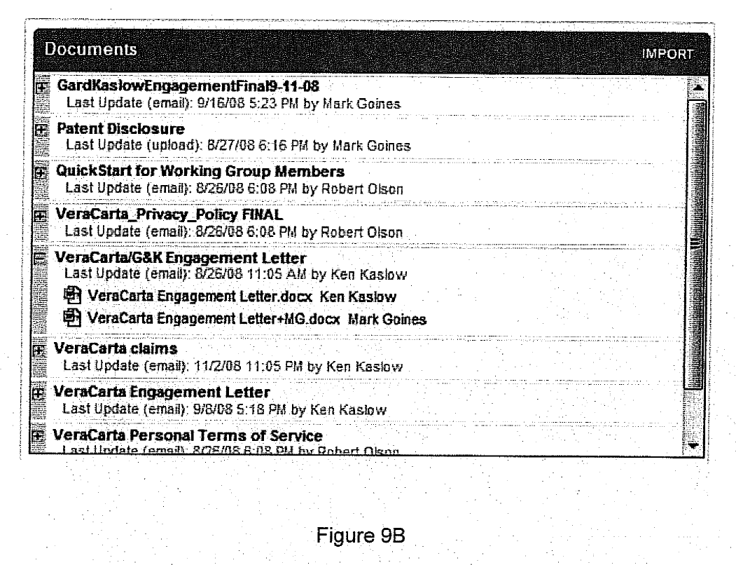

Any other desired information may be displayed in this view; as shown here, the actual document name is provided, along with the name of the base document of which the document is a nearly identical version. If desired, the document name may be hyper linked to the actual document so that clicking on the name opens the document. Similarly, the base document name may link to a collection of nearly identical documents, as shown in FIG. 9 below.

In addition to the email displays discussed above, it may be useful for a participant to be able to see the documents associated with a project at the same time. FIG. 9A is an illustration of another portion of a page such as might be displayed when the participant selects a project; for example, in some embodiments, the page portion shown in FIG. 9A is displayed along with the page portion shown in FIG. 5 for the selected project. The page portion shown in FIG. 9A contains a list of the documents that are associated with the project, listed alphabetically by title. Other orders of listing may be used as desired. An “import” button 902 again allows the participant to import other documents into the system, for example by bringing up a directory of the storage device attached to the participant's device much like an “open” command in the menu of many software applications.

The list of documents contained in the display of FIG. 9A may be a list of only different base documents, i.e., only those documents that are not nearly identical different versions of other documents on the list. A sign, again such as the “+” symbols 904, may indicate that there are different versions of the document available in the system. Clicking on the “+” symbol 904 for VeraCarta Engagement Letter, for example, may result in the display of FIG. 9B, in which that document has been expanded to show that there are two different versions of it, and the authors of those versions. In a typical technique of the art, the “+” symbol has now become a “−” symbol, and clicking on it returns the display to the form of FIG. 9A. If desired, the document names may link to the actual documents so that clicking on, for example, VeraCarta Engagement Letter.docx, opens the version of this document authored by Ken Kaslow.

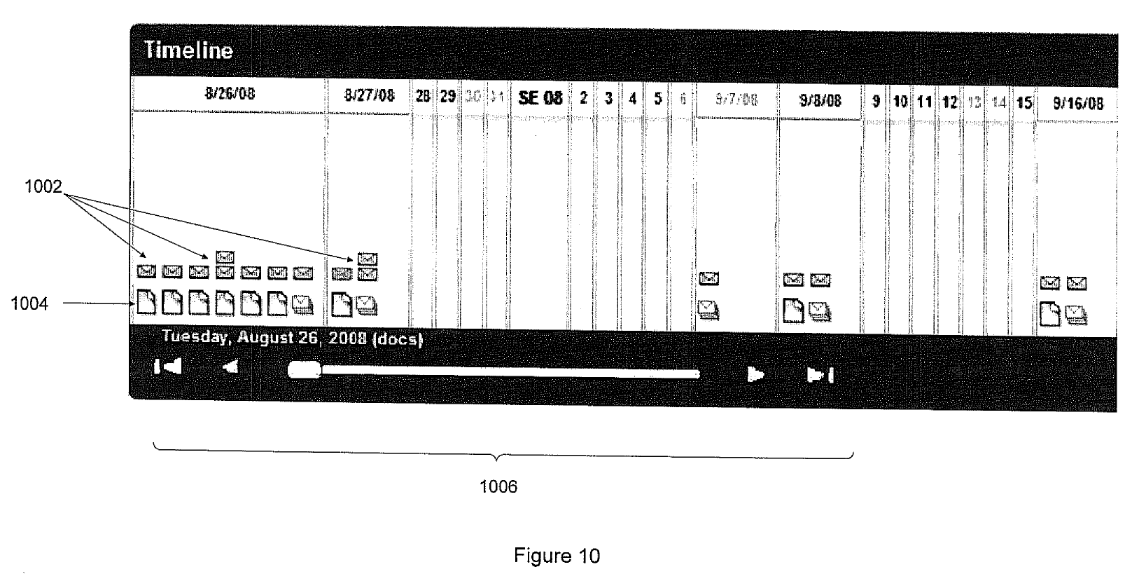

Any other desired information about a specific project may be displayed to the participant when the project is selected. For example, FIG. 10 is an illustration of still another portion of a page such as might be displayed when the participant selects a project. This portion contains a display of the project timeline indicating dates in chronological order; under each date are icons showing that a certain number of emails, represented by envelopes 1002, and documents, indicated by pages 1004, related to the project (i.e., those displayed, for example, in FIGS. 5-8 and 9A-B) were sent on the indicated dates. If the timeline does not fit within the allotted space, a slider bar 1006 may be used to view any desired portion of the timeline.

The email and document icons 1002 and 1004 respectively may be hyperlinked to the actual emails and documents respectively, such that placing a cursor on a given icon causes a window to be displayed with information about the email or document represented, and clicking on the icon opens the email or document itself. The information window may contain, for example, the identities of the sender and recipients and subject line of an email, or the owner and title of a document. This provides another possible way for a participant to quickly locate a desired email or document.

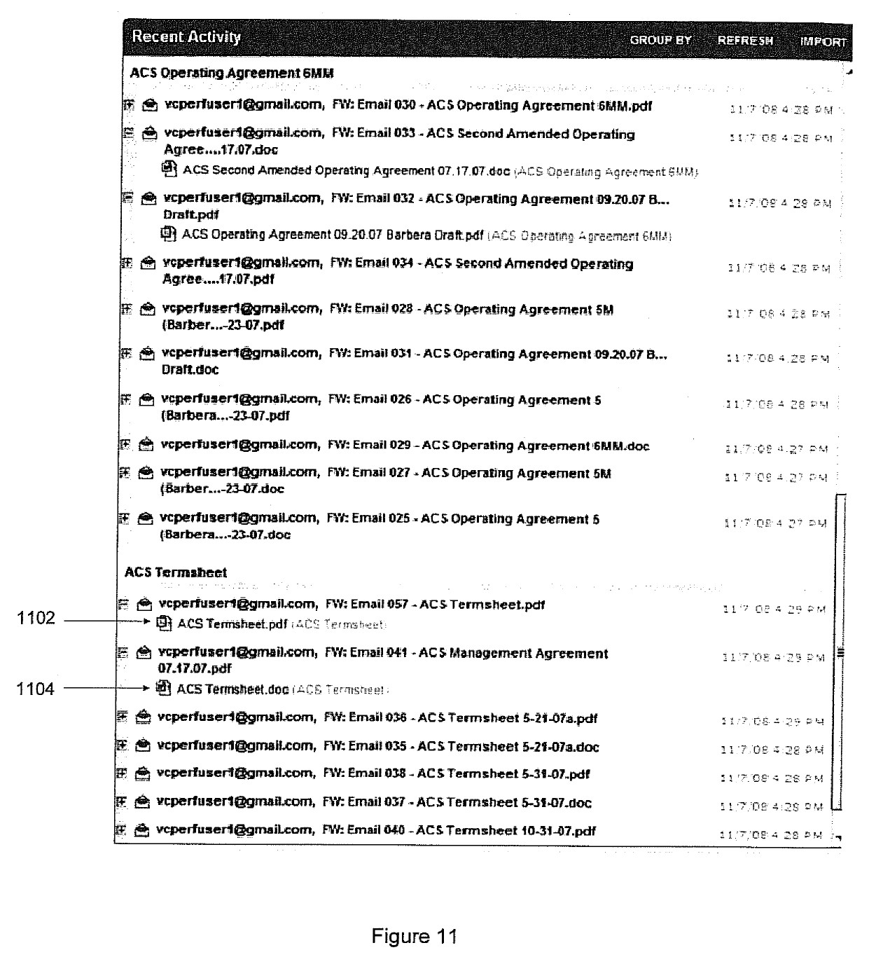

FIG. 11 illustrates a view similar to FIG. 8 but for a different project. Again the emails have been grouped by the document attached, and two of the emails related to the “ACS Termsheet” expanded to show the documents attached. In this instance, as discussed above, the documents have names that are not similar, and are not in the same format. One document is titled “ACS Termsheet” and, as indicated by both the full document title “ACS Termsheet.pdf” and the icon 1102, is in PDF format, while the other is titled “ACS Management Agreement” and is a Microsoft® Word document as indicated by icon 1104 and the “.doc” extension. In this instance, the system has compared the text of each document and it has been determined that they are nearly identical and thus versions of the same document. It can be seen on FIG. 11 that there are several other versions of the same document in both PDF and Word formats, all titled “ACS Termsheet,” and thus “ACS Termsheet is also the name of the document group.

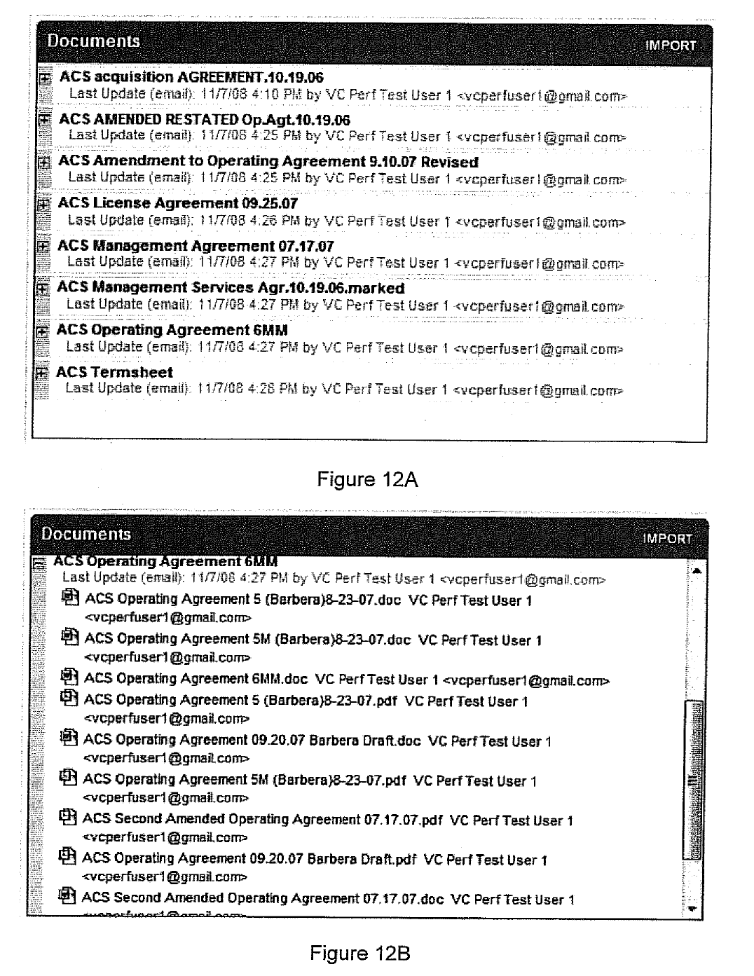

Similarly, FIG. 12A illustrates another portion of a view of the project shown in FIG. 11, but with the Documents list similar to that of FIG. 9A. Expanding the document “ACS Operating Agreement” by clicking on the “+” sign results in the view of FIG. 12B, as discussed with respect to FIG. 9B above. It can be seen that again some of the documents are in PDF format and some in Word format, and that some documents are titled “ACS Operating Agreement” and some “ACS Second Amended Operating Agreement.” Again, however, the grouping indicates that all of the documents in the group are alternative versions of a single base document and nearly identical to one another.

Many EDM systems allow for the express designation of authorized viewers, i.e., the granting of permissions to a limited set of people to view and/or modify a document. In the above illustrations, permission is implicit in the use of email. It is assumed that the sample displays are unique to each participant, who sees only those emails and documents which the participant has either sent or received. The attachment of documents to emails thus acts as the de facto granting of permission to the recipients to view the document, and further the de facto granting of permission to the recipients to allow others to view the document, i.e. by forwarding the email with the document attached.

A more specific permission function could be utilized in some embodiments of the present invention, such that a specific document could have associated with it a list of authorized viewers. Such a list could either be created from the list of senders and recipients of emails to which the document is attached, and any authorized viewer could add other project participants as authorized viewers without having to forward the document by email. Alternatively, the creator of a document which is imported to the system by means other than email could explicitly identify those participants who are to be authorized to view and/or modify a document, much as in an EDM system.

Other features may be added as desired. For example, in addition to sorting emails by date, sender, title or document, and documents by title or near duplicate detection, if desired it would be possible to scan both emails and documents for key words, or to parse them according to a natural language algorithm, and to group them by such key words or by concepts or subjects detected by such a natural language algorithm.

Finally, it is again to be noted that the use of emails and documents as examples is not exhaustive of the scope of the present invention. It will be clear to one of skill in the art that text messages may easily be included in a fashion almost identical to the methods described with respect to email above. Speech recognition software may be used to reduce voice messages to text and include them in a system according to the present invention as well. Other communications that may be reduced to text may also be included.

The invention has been explained above with reference to several embodiments. Other embodiments will be apparent to those skilled in the art in light of this disclosure. The present invention may readily be implemented using different orders of steps, configurations other than those described in the embodiments above, or in conjunction with systems other than the embodiments described above. It should also be appreciated that the present invention can be implemented in numerous ways, including as a process, an apparatus, a system, a computer readable storage medium such as a hard disk drive, floppy disk, optical disc such as a compact disc (CD) or digital versatile disc (DVD), flash memory, etc., on which program instructions for performing the methods described herein are stored, or a computer network wherein the program instructions are sent over optical or electronic communication links. It should be noted that the order of the steps of the methods described herein may be altered within the scope of the invention. These and other variations upon the embodiments are intended to be covered by the present invention, which is limited only by the appended claims.

What is claimed is:

1. A method for managing a written transaction between a plurality of participants in a computing system, comprising:
obtaining a plurality of communications that are related to the transaction;
obtaining a plurality of documents that are related to the transaction;
determining which participants are parties to each of the plurality of communications;
determining whether any of the documents are related to any of the communications;
determining any relationships between the communications;
determining any relationships between the documents;
storing the communications and documents and all of the determined relationships between them; and
displaying the communications and documents and the determined relationships between them on an electronic display in the computing system.

2. The method of claim 1 wherein a plurality of the communications are emails, and wherein determining which participants are parties to each of the plurality of communications further comprises determining the sender and recipients of each email.

3. The method of claim 2 wherein displaying the communications and documents and the determined relationships between them further comprises displaying the emails in groups according to the date sent.

4. The method of claim 2 wherein displaying the communications and documents and the determined relationships between them further comprises displaying the emails in groups according to the sender.

5. The method of claim 2 wherein displaying the communications and documents and the determined relationships between them further comprises displaying the emails in groups according to the recipient.

6. The method of claim 2 wherein displaying the communications and documents and the determined relationships between them further comprises displaying the emails in groups according to the subject lines of the emails.

7. The method of claim 2 wherein determining whether any of the documents are related to any of the communications further comprises determining whether any of the documents are attachments to any of the emails.

8. The method of claim 7 wherein determining any relationships between the documents further comprises determining whether two or more documents are near duplicates of each other.

9. The method of claim 8 wherein displaying the communications and documents and the determined relationships between them further comprises displaying the emails in groups in which each email has attached to it a document that is a near duplicate of a document attached to each other email in the group.

10. The method of claim 9 wherein displaying the communications and documents and the determined relationships between them further comprises displaying to one of the plurality of participants all communications to which the participant is a party.

11. The method of claim 7 wherein determining whether two or more documents are near duplicates of each other further comprises using a Dirichlet-smoothed Kullback-Leibler divergence as a baseline distance metric to drive clustering.

12. The method of claim 1 wherein determining any relationships between the documents further comprises determining whether two or more documents are near duplicates of each other.

13. The method of claim 12 wherein determining whether two or more documents are near duplicates of each other further comprises using a Dirichlet-smoothed Kullback-Leibler divergence as a baseline distance metric to drive clustering.

14. The method of claim 13 wherein the Dirichlet-smoothed Kullback-Leibler divergence uses the average of the two non-symmetric distance measures between the two documents as the baseline distance metric.

15. The method of claim 11 wherein displaying the communications and documents and the determined relationships between them further comprises displaying the documents in groups of documents in which each document in a group is a near duplicate of each other document in the group.

16. The method of claim 1 wherein displaying the communications and documents and the determined relationships between them further comprises displaying to one of the plurality of participants all communications to which the participant is a party.

17. A computing system for managing a written transaction between a plurality of participants, comprising:
input means for obtaining a plurality of communications and a plurality of documents that are related to the transaction;
a processor configured to:
determine which participants are parties to each of the plurality of communications;
determine whether any of the documents are related to any of the communications;
determine any relationships between the communications; and
determine any relationships between the documents;
a data storage device for storing the communications and documents and all of the determined relationships between them; and
an electronic display for displaying the communications and documents and the determined relationships between them.

18. The computing system of claim 17 wherein the processor is further configured to determine any relationships between the documents by determining whether two or more documents are near duplicates of each other.

19. The computing system of claim 18 wherein the processor is further configured to determine any relationships between the communications by determining whether any communication has attached to it a document that is a near duplicate of a document attached to another communication.

20. A computer-readable storage medium having embodied thereon a program, the program being executable by a processor to perform a method comprising:
obtaining a plurality of communications that are related to a written transaction between a plurality of participants;
obtaining a plurality of documents that are related to the transaction;
determining which participants are parties to each communication;
determining whether any of the documents are related to any of the communications;
determining any relationships between the communications;
determining any relationships between the documents;
storing the communications and documents and all of the relationships between them;
displaying the communications and documents and the relationships between them.
